(19) United States
(12) Patent Application Publication
(10) Pub. No.: US 2011/0149952 A1
(43) Pub. Date: Jun. 23, 2011

(54) MULTIMEDIA TERMINAL ADAPTER AND REMOTE CONNECTION METHOD

(75) Inventor: HAU-LUNG HUANG, Tu-Cheng (TW)

(73) Assignee: HON HAI PRECISION INDUSTRY CO., LTD., Tu-Cheng (TW)

(21) Appl. No.: 12/767,709

(22) Filed: Apr. 26, 2010

(30) Foreign Application Priority Data
Dec. 18, 2009 (CN) 200910311818.4

(51) Int. Cl. H04L 12/66

(52) U.S. Cl. 370/352

(57) ABSTRACT

A multimedia terminal adapter saves IP addresses of the multimedia terminal adapter and second communication devices as an IP address list, and relationships between the IP addresses of the second communication devices and user ports as a relationship list. The multimedia terminal adapter sends the IP address list to the first communication device, and receives a selected IP address of a selected second communication from the first communication device. The multimedia terminal adapter further searches one user port corresponding to the selected IP address, and opens the searched user port to establish a remote connection between the first communication device and the selected second communication device.

### BACKGROUND

1. Technical Field

Embodiments of the present disclosure relate to network communications, and particularly to a multimedia terminal adapter and a remote connection method.

2. Description of Related Art

Remote control is a network development subject. Home networking is based on remote controls. In the operation of remote controls, a controlling device needs to know an Internet protocol (IP) address of a controlled device, to establish a connection. However, current networks often utilize dynamic IP addresses, so it is difficult for the controlling device to inquire the IP address of the controlled device.

Presently, the controlled device utilizes a static IP address, or connects to a dynamic domain name server (DDNS), in order to overcome the above problem. However, the static IP address may have potential security problems, and connecting to the DDNS takes a long time to complete the operation. It is therefore desirable to find a new device and method can overcome the above mentioned problems.

### BRIEF DESCRIPTION OF THE DRAWINGS

FIG. 1 depicts a schematic diagram of an application environment of a remote control system of the present disclosure.

FIG. 2 depicts a block diagram of an exemplary embodiment of a multimedia terminal adapter of the present disclosure.

FIG. 3 depicts a flowchart of an exemplary embodiment of a remote connection method of the present disclosure.

### DETAILED DESCRIPTION

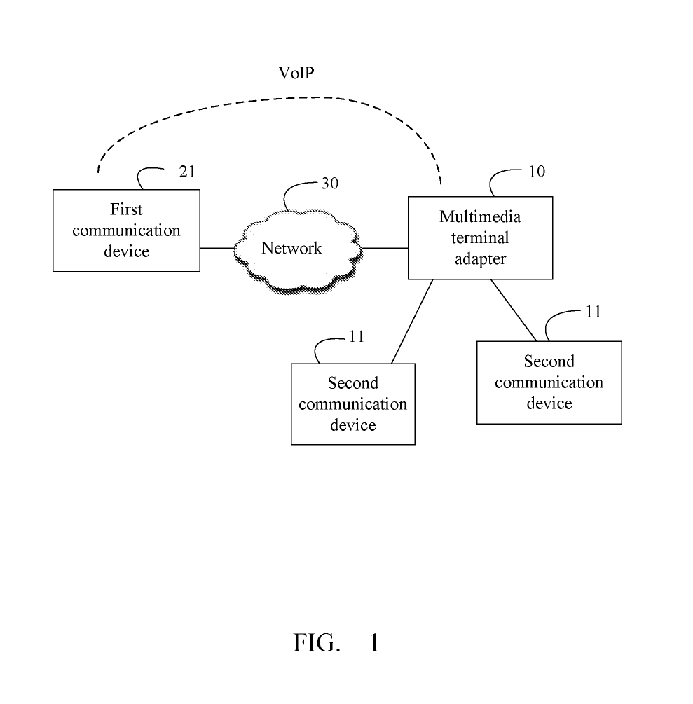

Referring to FIG. 1, an application environment of a remote control system comprises a first communication device 21, a plurality of second communication devices 11, and a multimedia terminal adapter (MTA) 10 in a network 30. The multimedia terminal adapter (MTA) 10 is operable to establish a remote connection between the first communication device 21 and one of the plurality of second communication devices 11.

The first communication device 21 and the second communication devices 11 may be computers, personal digital assistants (PDA), or mobile Internet devices (MIDs). The multimedia terminal adapter 10 may be a voice over Internet protocol (VoIP) gateway or a modem.

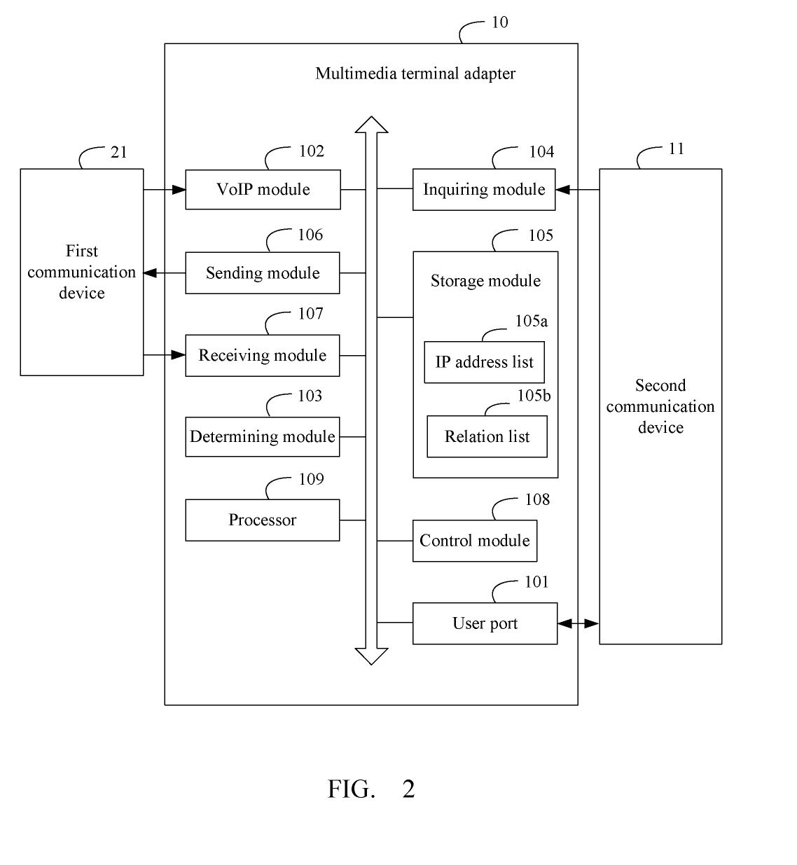

Referring to FIG. 2, a block diagram of an exemplary embodiment of the multimedia terminal adapter 10 of FIG. 1 is shown. The multimedia terminal adapter 10 comprises a plurality of user ports 101, a VoIP module 102, a determining module 103, an inquiring module 104, a storage module 105, a sending module 106, a receiving module 107, a control module 108, and a processor 109.

The aforementioned modules 101-108 may include one or more computerized instructions executed by the processor 109.

The plurality of user ports 101, shown one as an example in FIG. 2, are connected to the plurality of second communication devices 11. In one embodiment, the plurality of user ports 101 correspond to the IP addresses of the plurality of second communication devices 11, respectively. The IP addresses may be static IP addresses or dynamic IP addresses.

The VoIP module 102 receives a VoIP calling request from the first communication device 21.

The determining module 103 determines whether the VoIP calling request is a remote control request. In one embodiment, the determining module 103 predefines a group of numbers, and regards the VoIP calling request as a remote control request, if the VoIP calling request contains the predefined group of numbers.

The inquiring module 104 inquires the IP addresses of the multimedia terminal adapter 10 and the second communication devices 11, and the relationships between the IP addresses of the second communication devices 11 and the user ports 101. In one embodiment, the inquiring module 104 inquires if the VoIP calling request is a remote control request.

The storage module 105 saves the IP addresses of the multimedia terminal adapter 10 and the second communication devices 11 such as an IP address list 105a, and saves the relationships between the IP addresses of the second communication devices 11 and the user ports 101 as a relationship list 105b.

The sending module 106 sends the IP address list 105a to the first communication device 21 from which the first communication device 21 can select the IP address of one of the second communication devices 11. In one embodiment, the sending module 106 sends the IP address list 105a to the first communication device 21 by uploading the IP address list 105a to a predefined website. In other embodiments, the sending module 106 may send the IP address list 105a to the first communication device 21 by VoIP calling.

In one embodiment, the multimedia terminal adapter 10 provides the IP address list 105a of the plurality of second communication devices 11 to the first communication device 21, when the second communication devices 11 utilize dynamic IP addresses, to meet the requirements of remote control between the first communication device 21 and the second communication devices 11.

The receiving module 107 receives the selected IP address of the selected second communication device 11 from the first communication device 21.

The control module 108 searches for one user port 101 corresponding to the selected IP address of the selected second communication device 11 in the relationship list 105b, and opens the searched user port 101, to establish the remote connection between the first communication device 21 and the selected second communication device 11. In one embodiment, opening the selected user port 101 is operable to transmit controlling instructions from the first communication device 21 to the second communication device 11.

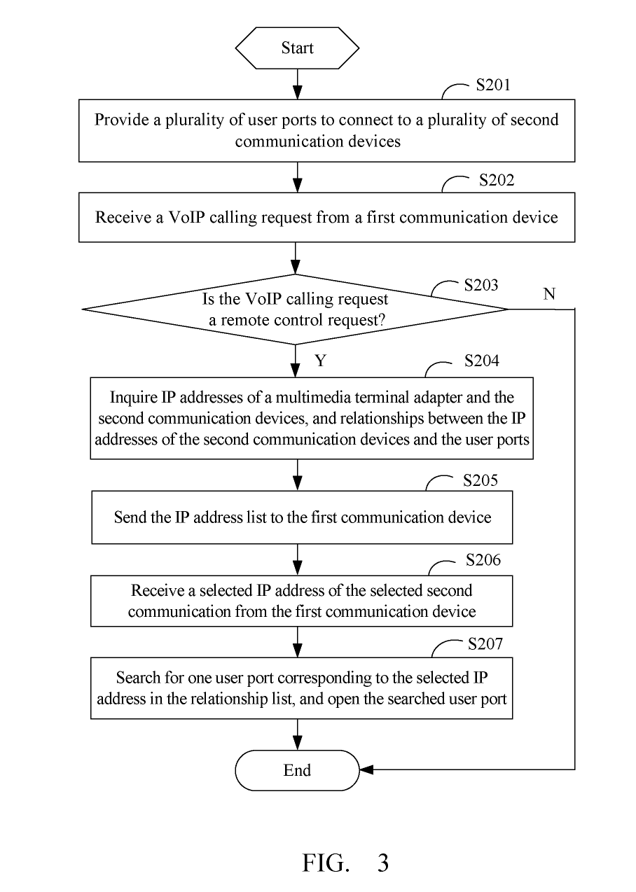

Referring to FIG. 3, one exemplary embodiment of a remote connection method is shown. In one embodiment, the remote connection method is applied in the multimedia terminal adapter 10 in FIG. 2, to establish a remote connection between the first communication device 21 and one of the plurality of second communication devices 11. Depending on the embodiment, additional blocks may be added, others deleted, and the ordering of the blocks may be changed.

In block S201, the multimedia terminal adapter 10 provides a plurality of user ports 101, connected to the plurality of second communication devices 11, and corresponding to the IP addresses of the plurality of second communication devices 11, respectively.

In block S202, the VoIP module 102 receives a VoIP calling request from the first communication device 21.

In block S203, the determining module 103 determines whether the VoIP calling request is a remote control request. The flow ends, if the VoIP calling request is not a remote control request. The flow goes to block S204, if the VoIP calling request is a remote control request.

In block S204, the inquiring module 104 inquires the IP addresses of the multimedia terminal adapter 10 and the second communication devices 11, and the relationships between the IP addresses of the second communication devices 11 and the user ports 101. The storage module 105 saves the IP addresses of the multimedia terminal adapter 10 and the second communication devices 11 as an IP address list 105a, and saves the relationships between the IP addresses of the second communication devices 11 and the user ports 101 as a relationship list 105b, respectively.

In block S205, the sending module 106 sends the IP address list 105a to the first communication device 21. The sending module 106 sends the IP address list 105a to the first communication device 21 by uploading the IP address list 105a to a predefined website. In other embodiments, the sending module 106 may send the IP address list 105a to the first communication device 21 by VoIP calling. The multimedia terminal adapter 10 provides the IP address list 105a of the plurality of second communication devices 11, especially when the second communication device 11 utilizes adapting dynamic IP addresses, to meet the requirements of remote control between the first communication device 21 and the second communication device 11.

In one embodiment, the first communication device 21 selects the one IP address of a selected second communication device 11, according to the IP address list 102a. The first communication device 21 sends the selected IP address of the selected second communication device 11 from the first communication device 21.

In block S206, the receiving module 107 receives the selected IP address of the selected second communication from the first communication device 21.

In block S207, the control module 108 searches for one user port 101 corresponding to the selected IP address of the selected second communication device 11 in the relationship list 105b, and opens the searched user port 101, to establish the remote connection between the first communication device 21 and the selected second communication device 11.

The description of the present disclosure has been presented for purposes of illustration and description, and is not intended to be exhaustive or limited to the disclosure in the form disclosed. Many modifications and variations will be apparent to those of ordinary skill in the art. Various embodiments were chosen and described in order to best explain the principles of the disclosure, the practical application, and to enable others of ordinary skill in the art to understand the disclosure for various embodiments with various modifications as are suited to the particular use contemplated.

What is claimed is:

1. A multimedia terminal adapter, to establish a remote connection between a first communication device and one of a plurality of second communication devices, the multimedia terminal adapter comprising:
a voice over Internet protocol (VoIP) module, for receiving a VoIP calling request from the first communication device;
a plurality of user ports, connected to the plurality of second communication devices, the plurality of user ports corresponding to IP addresses of the plurality of second communication devices, respectively;
a determining module to determine whether the VoIP calling request is a remote control request;
an inquiring module to inquire IP addresses of the multimedia terminal adapter and the second communication devices, and relationships between the IP addresses of the second communication devices and the user ports, when the VoIP calling request is the remote control request;
a storage module to save the IP addresses of the multimedia terminal adapter and the second communication devices as an IP address list, and save the relationships between the IP addresses of the second communication devices and the user ports as a relationship list;
a sending module to send the IP address list to the first communication device, wherein the first communication device selects one IP address of one of the second communication devices which is required to be connected according to the IP address list;
a receiving module to receive the selected IP address of the one of the second communication devices from the first communication device;
a control module to search for one user port corresponding to the selected IP address of the one of the second communication device in the relationship list, and open the searched user port to establish the remote connection between the first communication device and the one of the second communication device; and
a processor to drive the VoIP module, the plurality of user ports, the determining module, the inquiring module, the storage module, the sending module, the receiving module, and the control module.

2. The multimedia terminal adapter as claimed in claim 1, wherein the sending module sends the IP address list to the first communication device by uploading the IP address list to a predefined website.

3. The multimedia terminal adapter as claimed in claim 1, wherein the sending module sends the IP address list to the first communication device by VoIP calling.

4. A remote connection method, applied in a multimedia terminal adapter, to establish a remote connection between a first communication device and one of a plurality of second communication devices, wherein the remote connection method comprising:
providing a plurality of user ports, connected to the plurality of second communication devices, and corresponding to IP addresses of the plurality of second communication devices, respectively;
receiving a VoIP calling request from the first communication device;
determining whether the VoIP calling request is a remote control request;
inquiring IP addresses of the multimedia terminal adapter and the second communication devices, and relationships between the IP addresses of the second communication devices and the user ports, if the VoIP calling request is the remote control request;
saving the IP addresses of the multimedia terminal adapter and the second communication devices as an IP address list, and saving the relationships between the IP addresses of the second communication devices and the user ports as a relationship list;
sending the IP address list to the first communication device, wherein the first communication device selects one IP address of a selected second communication device, according to the IP address list;
receiving a selected IP address of the selected second communication device from the first communication device; and
searching one user port corresponding to the selected IP address of the selected second communication in the relationship list; and
opening the searched user port, to establish the remote connection between the first communication device and the selected second communication device.

5. The remote connection method as claimed in claim 4, wherein the block of sending the IP address list to the first communication device is by uploading the IP address list to a predefined website.

6. The remote connection method as claimed in claim 4, wherein the block of sending the IP address list to the first communication device is by VoIP calling.
